(19) United States
(12) Patent Application Publication
(10) Pub. No.: US 2008/0270364 A1
(43) Pub. Date: Oct. 30, 2008

(54) EXPANSION RULE EVALUATION

(75) Inventors: Roberto J. Bayardo, Morgan Hill, CA (US); Rajat Jain, New York, NY (US); Ramakrishnan Srikant, Cupertino, CA (US); Diane L. Tang, Portola Valley, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/107,381

(22) Filed: Apr. 22, 2008

Related U.S. Application Data
(60) Provisional application No. 60/915,094, filed on Apr. 30, 2007.

(51) Int. Cl. G06F 7/06

(52) U.S. Cl. 707/3; 707/E17.014

(57) ABSTRACT

One aspect of the subject matter described in this specification can be embodied in methods that include the actions of monitoring the performance of content items selected in response to an expanded query, identified by a query expansion rule; determining a baseline performance that represents the performance of any presented content item; and determining an expansion rule performance based on the performance of the content items relative to the baseline performance. Other implementations of this aspect include corresponding systems, apparatus, and computer program products.

### CROSS-REFERENCE TO RELATED APPLICATIONS

This application claims priority under 35 U.S.C. § 119(e) to U.S. Provisional Application Ser. No. 60/915,094, titled “CONTENT ITEM IDENTIFICATION” filed Apr. 30, 2007, the disclosure of which is incorporated herein by reference.

### BACKGROUND

This document relates to content presentation.

Interactive media (e.g., the Internet) has the potential to improve targeting of advertisements to select audiences. For example, search engines provide search capabilities based on a user query (e.g., keywords entered by the user). The user query can include one or more search terms. The search engine can identify and, optionally, rank the content items based on the search terms in the user query and present the content items to the user (e.g., according to the rank). This query can also be an indicator of the type of information of interest to the user. Comparing the user query to a list of keywords specified by an advertiser, it is possible to provide targeted advertisements to the user.

Another form of online advertising is advertisement syndication, which allows advertisers to extend their marketing reach by distributing advertisements to additional partners. For example, third party online publishers can place an advertiser's text or image advertisements on web pages that have content related to the advertisement. As the users are likely interested in the particular content on the publisher webpage, they are also likely to be interested in the product or service featured in the advertisement. Accordingly, such targeted advertisement placement can help drive online customers to the advertiser's website.

However, comparing a user search query to a list of keywords specified by an advertiser does not always provide the most desirable targeted advertisements for the user. Differences in keyword semantics may result in less relevant advertisements being displayed. Displaying less relevant advertisements, for example, in response to a search query, can result in diminished advertising effectiveness.

### SUMMARY

In general, one aspect of the subject matter described in this specification can be embodied in methods that include the actions of monitoring performance of content items selected in response to an expanded query identified by a query expansion rule, determining a baseline performance that represents the performance of any presented content item, and determining an expansion rule performance based on the performance of the content items relative to the baseline performance. Other implementations of this aspect include corresponding systems, apparatus, and computer program products.

These and other implementations can optionally include one or more of the following features. The method can classify the query expansion rule based on the expansion rule performance. The query expansion rule can be classified as invalid or valid based on a threshold performance level. The method can prevent an invalid query expansion rule from being used.

The baseline performance can be determined with a bootstrap estimation of a metric. The bootstrap estimation of a metric can be determined by a method including the steps of identifying resample sets with samples randomly selected from the monitored performance with replacement (e.g., replacing each randomly selected sample to the monitored performance sample after each selection); determining a resample performance metric for each resample set; and identifying a resample metric distribution associated with the resample metrics.

The expansion rule performance based on the performance of the content items relative to the baseline performance can be determined by a process including the steps of normalizing an observed metric associated with the content items and comparing the normalized metric to the expected metric distribution to determine if the normalized metric satisfies a threshold value associated with the distribution.

The performance of the content items selected in response to the expanded query identified by the query expansion rule can be monitored by a process including the steps of receiving a search query, expanding the query with the query expansion rule, presenting content items associated with the expanded query, and observing metrics associated with the content items.

Particular embodiments of the subject matter described in this specification can be implemented so as to realize one or more of the following advantages. Expansion rule performance can be determined with fewer samples. Expansion rules that are performing below a threshold can be disabled.

The details of implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an example online advertising environment.

FIG. 2 is a block diagram of an example content item identification system.

FIG. 3 is a flow diagram of an example process for determining the performance of a query expansion rule.

FIG. 4 is a flow diagram of an example process for determining a baseline performance.

FIG. 5 is a flow diagram of an example process for monitoring performance of the content items selected in response to the expanded query.

FIG. 6 is a flow chart illustrating an example process 600 for determining the expansion rule performance.

### DETAILED DESCRIPTION

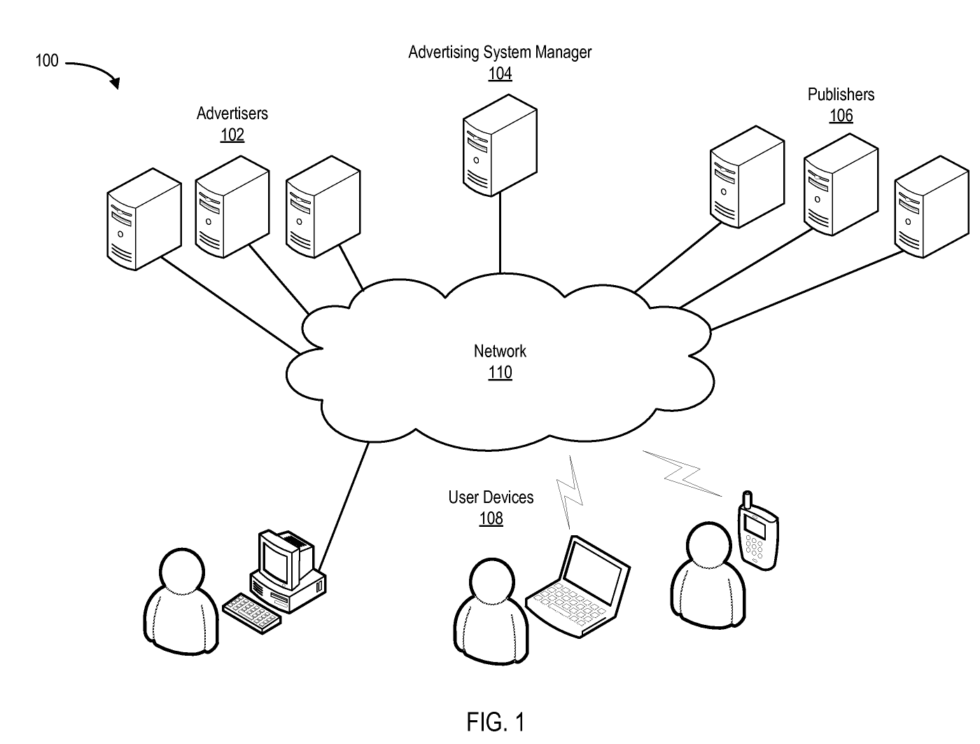

FIG. 1 is a block diagram of an example online advertising environment 100. In some implementations, advertisers 102 can directly, or indirectly, enter, maintain, and track advertisement information in an advertising system manager 104. The advertisements may be in the form of graphical advertisements, such as banner advertisements, text only advertisements, image advertisements, audio advertisements, video advertisements, advertisements combining one of more of any of such components, etc. The advertisements may also include embedded information, such as a links, meta-information, and/or machine executable instructions. Publishers 106 may submit requests for advertisements to the advertising system manager 104. In these implementations, the advertising system manager 104 responds by providing advertisements to the publisher 106 for placement on the publisher's web property (e.g., website or other network-distributed content). Though advertisements are referenced, other content items (e.g., forms of sponsored content) can be served by the advertising system manager 104.

User devices 108 and the advertisers 102 can provide usage information to the advertising system manager 104. The usage information can include impression information (e.g., the advertisement presented and information related to the page configuration). The usage information can also include for example, whether or not a conversion (e.g., a user completing an action on a website) or click related to an advertisement has occurred. This usage information can also include measured or observed user device actions related to served advertisements. The usage information can be used to determine, for example, a click through rate (CTR) (e.g., number of clicks/number of impressions).

In response to the usage information provided, the advertising system manager 104 performs financial transactions, such as crediting publishers 106 and charging the advertisers 102, for example, according to the cost per click (CPC) for the advertisement served. Additionally, the advertising system manager 104 can maintain statistics regarding the performance of the advertisements (e.g., click-through rate, number of clicks, number of impressions, advertisement placement position, etc).

A network 110, such as a local area network (LAN), wide area network (WAN), the Internet, or a combination thereof, connects the advertisers 102, the advertising system manager 104, the publishers 106, and the user devices 108.

An example publisher 106 is a general content server that receives requests for content (e.g., articles, discussion threads, music, video, graphics, search results, web page listings, information feeds, etc.), and retrieves the requested content in response to the request. The content server can submit requests for advertisements to an advertisement server in the advertising system manager 104. The advertisement request may include a number of advertisements desired. The advertisement request may also include content request information. The content request information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server can combine the requested content with the advertisements provided by the advertising system manager 104. The combined content and advertisements can be sent to the user device 108 that requested the content for presentation in a viewer (e.g., a browser or other content display system). The content server can transmit information about the advertisements back to the advertisement server, including information describing how, when, and/or where the advertisements are to be rendered (e.g., in HTML or JavaScript™).

Another example publisher 106 is a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search engine 205,” Seventh International World Wide Web Conference, Brisbane, Australia and in U.S. Pat. No. 6,285,999, both of which are incorporated herein by reference each in their entirety. Search results can include, for example, lists of web page titles, snippets of text extracted from those web pages, and hypertext links to those web pages, and may be grouped into a predetermined number of search results.

The search service can submit a request for advertisements to the advertising system manager 104. The request may include a number of advertisements desired. The number of advertisements may depend on the search results, the amount of screen or web page space occupied by the search results, the size and shape of the advertisements, etc. The request for advertisements can also include the query (as entered or parsed), information based on the query (such as geo-location information, whether the query came from an affiliate and an identifier of such an affiliate), and/or information related to the search results.

The information related to the search results may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

In some implementations, the request can include an expanded query that is identified by a query expansion rule. A query expansion rule can be, for example, a semantic rule that identifies phrases that are related to the original query. The expanded query can include the original query and additional query terms or phrases that are identified by the query expansion rule. The advertising system manager 104 can identify advertisements that are related to the expanded query and, in turn, present the identified advertisements to, for example, the search service for presentation. The additional query phrases contained in the expanded query can be identified, for example, by identifying terms or phrases (e.g., one or more terms) that are related to, similar to or otherwise associated with the original query.

The search service can combine the search results with the advertisements provided by the advertising system manager 104. This combined information can then be forwarded to the user device 108 that requested the content. The search results can be maintained as distinct from the advertisements, so as not to confuse the user between paid advertisements and the search results.

When additional search query terms/phrases identified by the query expansion rule are used to identify relevant advertisements, the publisher may want to determine the performance of the advertisements selected based on the additional search query terms/phrases. For example, the publisher may want to know whether the advertisements have a high click-through rate. Therefore, the search service can transmit information about the performance of the advertisement (e.g., whether it was clicked) back to the advertising system manager 104.

Similarly, the search service can transmit impression information indicating when, where, and/or how the advertisement was rendered back to the advertising system manager 104. For example, the search service can transmit information about where the advertisement was displayed, and the configuration of the display page. In turn, the advertising system manager 104 can determine quality metrics for the advertisements identified in response to additional search query phrases provided by the query expansion rule. The publishers can use these performance metrics to determine whether they want to continue using the query expansion rule that resulted in the identification of the advertisement. While reference is made to expanding a query search on line, the methods, systems and products proposed can be used to expand other keywords or terms associated with other forms of content items (e.g., radio, television, print, or other media items) to produce related/relevant results for presentation in a corresponding media environment. For example, a query expansion rule can be used to select audio advertisements provided over the airwaves to users.

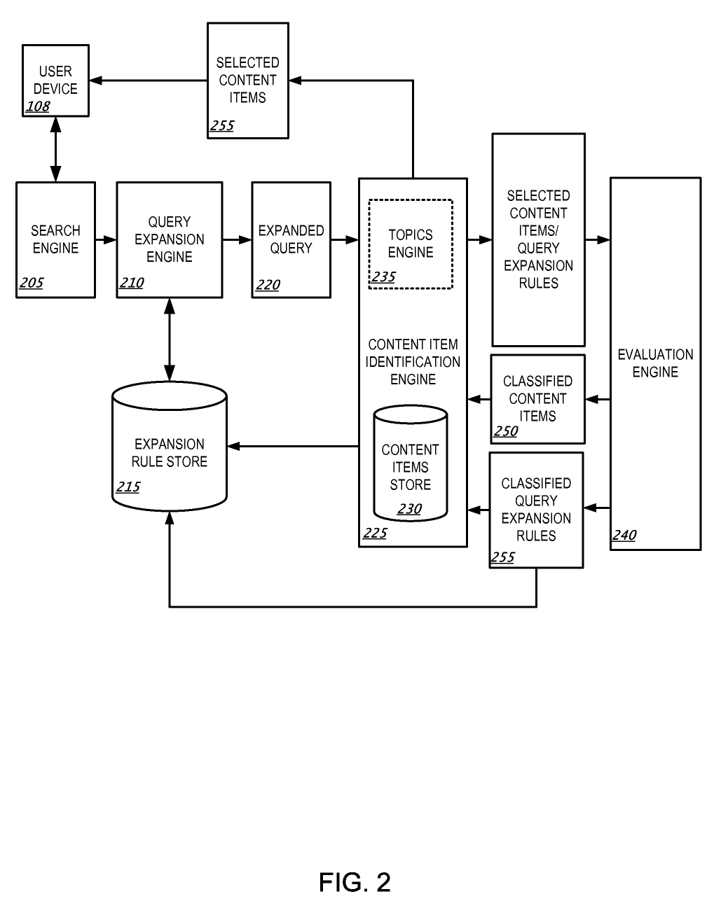

FIG. 2 is a block diagram of an example content item identification system 200. The content item identification system 200 can be implemented, for example, in an online advertising environment 100. For clarity of presentation, the description that follows uses a search service (e.g., search engine 205) as an example publisher 106 for describing the content item identification system 200. However, the content item identification system 200 can be implemented in other systems, or combinations of systems and by other publishers 106.

A search engine 205 receives a search query from a user device 108. In response, the search engine 205 provides search results that are related to the search query. In some implementations, the search engine 205 can submit the search query to the advertising system manager 104 to receive advertisements to serve with the search results.

The search engine 205 can also provide the search query to a query expansion engine 210. In response, the query expansion engine 210 retrieves a query expansion rule (e.g., rewrite rule) from an expansion rule store 215 and applies the query expansion rule to the search query. According to some implementations, the query expansion rule can be based on semantic rules that result in additional query terms/phrases being identified based on, for example, their relevance to the search query submitted by the user device 108.

For example, the query expansion engine 210 can receive a search query for “new cars” from a user device and apply expansion rules to identify related additional search query terms/phrases. The query expansion engine 210 can identify, for example, the phrases “used cars,” “car prices,” and “car dealer locator” as related to the query “new cars.” The query expansion engine 210 can form an expanded query 220 of the original query 205 containing the additional search query phrases and provide the expanded query 220 to the search engine 205. In turn, the search engine 205 can use the expanded query to identify relevant search results.

The query expansion engine 210 can provide the expanded query 220 and the search query to a content identification engine 225 that identifies the content items (e.g., advertisements) to be presented in response to the expanded query 220. In addition to advertisements, the content items can be a variety of other content (e.g., video, audio, text, news feeds, digital print, and images). The content items can be stored and retrieved from a content item store 230.

In some implementations, the content item identification engine 225 can identify content items by analyzing signals associated with the content items. Signals are metadata about the content items. In some implementations, the signals can be keywords that are related to the content items. A topics engine 235 can identify keywords related to the content items, for example, by retrieving text snippets from a web page associated with the content items. In some implementations, the advertiser can provide keywords that are associated with the advertisement.

For example, after identifying the keywords related to the content items, the topics engine 235 can compare the identified keywords to the expanded query 220. The topics engine 235 can then identify the content items that have identified keywords related to (e.g., identical to) the expanded query 220. The identified content items can be selected for presentation and returned to the user device 108. Other signals that are associated with the content items can also be identified (e.g., size of the advertisement, content type) and used in selecting advertisements for presentation.

An evaluation engine 240 can evaluate content items that are presented to the user device 108 in response to an expanded query. In some implementations, the content item evaluation engine 240 can monitor and analyze performance metrics associated with the content items. For example, the performance metrics associated with the content items can include a click-through rate. In some implementations, the click-through rate represents the probability that the content item will be clicked when it is presented. Other performance metrics associated with the content items can also be monitored and analyzed (e.g., an impression total, a click total, a content item location, etc.).

In some implementations, the performance metrics can be monitored and analyzed to determine whether the content item being presented is appropriate based on the expanded query. In turn, the performance of the query expansion rule(s) can be determined based on the performance of the content items presented in response to the expanded query. If the content items that are identified based on the expanded query have low performance metrics, then it can be presumed that the query expansion rule(s) are generating additional query terms/phrases that are not sufficiently related to the search query submitted by the user device 108. Therefore, a publisher can identify a low performing query expansion rule and take action (e.g., edit or disable the rule).

In some implementations, the evaluation engine 240 monitors a click count and number of impressions associated with the content items. A click count is the number clicks that the content item receives, while the number of impressions is the number of times the content item was presented on a web page. The click-through rate associated with a content item can be determined, for example, by dividing the click count by the number of impressions. The monitoring can take place for a sample period (e.g., 1000 impressions) sufficient to collect the number of impressions (e.g. page presentations) needed to determine the click-through rate with a desired accuracy. The evaluation engine 240 can associate the click counts and click-through rates for the content items with query expansion rules that provided expanded queries that resulted in presentation of the content items.

According to some implementations, performance metrics (e.g., click-through rate) can be normalized to account for the configuration of the advertisements on the search page (e.g., the position of the advertisement, number and position of other advertisements). A normalization factor can be determined for each configuration of an advertisement based on a reference configuration. The reference configuration can have a reference location for the content item of interest (e.g., top right advertisement position). Normalizing the performance metrics enables the metrics associated with content items that appear in different locations of the search page, and/or appear with different numbers of other advertisements to be compared and used together in subsequent determinations. Additionally, normalizing the performance metrics can facilitate determination of an expected metric value when a content item is presented in a different configuration.

For example, monitoring an advertisement can enable determination of a first click-through rate (p′) for an advertisement in a select configuration (c′). Using normalization constants (Nc′, Nc), a baseline click-through rate (p) for the advertisement in a second configuration (c) can be determined according to the equation

$$p = \frac{{p}^{′ *} Nc}{{Nc}^{′}}$$

Using the relationship presented above, a baseline click-through rate can be determined for an advertisement. In some implementations, the baseline click-through rate (p) can be, for example, the probability of an advertisement being clicked in the baseline configuration. This baseline click-through rate is independent of whether a query expansion rule was used. Using a baseline click-through rate independent of a query expansion rule ensures that query expansion rules will not degrade the average performance of the advertising system. The baseline click-through rate can be multiplied by the number of impressions associated with the advertisements to obtain a baseline click count. In turn, the performance of the advertisement can be determined by comparing the number of clicks received in the same number of impressions.

The performance of content items can be used to determine the performance of the query expansion rules. For example, if a query expansion rule identifies an expanded query that results in the selection of content items, then the performance of the content items can be used to determine the performance of the query expansion rule. However, the number of impressions for a particular content item selected in response to the application of a query expansion rule may not be statistically relevant. For example, it is possible that an advertisement is only selected in response to the application of a particular query expansion rule once a day. Accordingly, it may require a long period of time to collect a statistically relevant click count.

In some implementations, a bootstrap estimation can be used to estimate the performance of a content item relative to a baseline performance. Bootstrap estimation is a method for determining a sample distribution from as few as a single sampling. The distribution can be, for example, the distribution of a statistic (e.g., mean, variance) associated with the single sampling. Since the estimation is determined from a small number of samples, (e.g., a single sampling), the data required to determine the distribution is reduced.

According to some implementations, the distribution is determined from the single sampling by iteratively selecting a random sample from the single sampling. After each random sample selection, the random sample selected is placed back in the single sampling prior to the selection of the next random sample. Therefore, each sample within the single sampling has equal probability of being selected during each subsequent random sample selection. This random sample selection with replacement can be used to create multiple resample sets. Statistics can be calculated for each of the resample sets and the results can form a distribution. Since the single sampling represents the population from which it was drawn, the distribution of statistics of the resample sets represent the expected distribution of the statistics that would be realized if more samplings were collected from the population.

For example, if a single sampling has a sample size of n=6, resample sets having a sample size nᵢ=6 can be formed from the single sampling. The resample sets are formed by randomly selecting samples from the single sampling with replacement. Accordingly, each of the six samples in the single sampling is available for each random selection.

If the single sampling contained the samples 3.12, 0.00, 1.57, 19.67, 0.22 and 2.20 then an example resample set could contain the samples 1.57, 0.22, 0.22, 0.00, 3.12 and 19.67. This example resample set differs from the single sampling because it contains two instances of 0.22 and no instances of 2.20.

Once resample sets are selected, statistics associated with the resample sets are determined. The statistics of the resample sets can vary from the statistics of the single sampling because, as demonstrated above, the resample sets can vary from the single sampling since each of the samples is replaced before selecting the next random sample. For example, while the mean of the single sampling above is 4.46, the mean of the resample set above is 4.13. Similarly, another resample set containing the samples 0.22, 3.12, 1.57, 3.12, 2.2. and 0.22 has a mean of 1.74.

As demonstrated, the statistics (e.g., mean) can vary widely, but a resample distribution can be determined when statistics for more resample sets are calculated. As discussed, the resample distribution represents the expected distribution that would be realized if more samplings were performed from the population. The resample distribution can be used to identify the variability that is associated with the resample set statistics, and, in turn the statistics of the population. For example, the standard deviation of the means of the resample sets can be determined to characterize the variability associated with the means of the resample sets. Similarly, variance or any other measure of distribution variability can be used.

In some implementations, bootstrap estimation can be used to determine a resample click count (e.g., number of clicks) that a content item is expected to experience over a defined number of impressions. The bootstrap estimation can be used, for example, when the number of impressions associated with a content item is below a statistically relevant threshold. The resample click counts of the content items associated with a query expansion rule can be compared to a baseline click count that can be determined, in the manner discussed above, to determine the relative performance of the content item. In turn, the relative performance of the content item can be used to as a measure of the performance of the corresponding query expansion rule.

For example, the resample click count (e.g., number of clicks) for a content item selected in response to an expanded query (e.g., a selected content item) can be determined. In some implementations, the resample click count can be determined by iteratively selecting a random sample with replacement, from impression data associated with the content item. The impression data can include the configuration of the content item and whether the content item was clicked. A counter can be used to track the number of clicks expected for a content item based on the bootstrap estimation of the impression data.

For example, the counter can be incremented based on a heads outcome of a “coin flip” where heads has an example probability p=pb*Nc/Nb. The “coin flip” can be performed for each sample that is selected from the impression data. In some implementations, this process is iteratively continued until a sufficient number of samples is analyzed (e.g., 1000) to determine the sample click count (Ce). While a particular probability is provided, other probabilities for incrementing the counter can be used.

The determination of the performance metrics (e.g., click count) illustrated above can be iteratively performed to obtain a distribution of performance metrics. For example, the sample click count determination can be performed until a sufficient distribution is achieved (e.g., 1000 determinations). The click count distribution represents the distribution of the click count if additional samplings were collected by the monitoring.

In some implementations, impression data, which can include an observed click count (e.g., total number of clicks), can be compared to the click distribution. To compare the observed click count to the click distribution, the observed click count can be normalized. The observed click count can be normalized, for example, by applying a click normalization factor to the observed click count. For example, the click normalization factor can be a ratio of the number of sample clicks iterations performed (Y) relative to the number of sample points (e.g., impressions) (I) available in the monitored data. Other normalization factors can be used based on the application.

The normalized observed click count can be compared to the click distribution to identify whether the content items selected in response to a query expansion rule is outperforming the baseline click count. Similarly, a confidence level can be determined that identifies the probability that the content items selected in response to the query expansion rule will outperform the baseline click count. Publishers 106 can use the confidence levels to define which query expansion rules to use.

For example, publishers can determine that only query expansion rules that have a 95% confidence of resulting in selected content items that exceed the baseline click count will be used to identify expanded queries. To determine whether the content items that are associated with the query expansion rules exceed the 95% confidence rating the normalized click count can be compared to the click distribution for the content items. Here, the top 2.5% (5%/2) of the click distribution associated with the query expansion rule can be discarded from the distribution. In turn, the normalized click count can be compared to the highest remaining value in the click distribution. If the normalized click count is greater than or equal to the highest remaining value, then the query expansion rule has a 95% confidence of outperforming the baseline.

In some implementations, a bootstrap estimation can be used to identify the variance of the mean of the confidence score. For example, the mean of the confidence level can be 95% while the variance is 2.5%. In this situation, a conservative confidence level can be determined, for example, by subtracting the variance from the mean confidence level. Thus, the conservative confidence level associated with the example query expansion rule will be 92.5%.

Based on the determined performance of the query expansion rule, the evaluation engine 240 can classify a query expansion rule. For example, the evaluation engine 240 can classify the query expansion rule as invalid, valid, and/or undecided. Additional or fewer classifications can be utilized to classify the query expansion rule.

In some implementations, the evaluation engine 240 can classify a query expansion rule as valid if its associated performance level is above a threshold. For example, the threshold can be a threshold confidence level and the confidence level of the query expansion rule can be compared to the threshold confidence level. For example, the evaluation engine 240 can classify the query expansion rule as valid if it satisfies the valid confidence threshold. A valid query expansion rule will continue to be used to generate additional search queries.

Conversely, the evaluation engine 240 can classify a query expansion rule as invalid if its associated performance level is below a threshold. In response to classifying a query expansion rule as invalid, the content item identification engine can, for example, disable the query expansion rule so that it will not be used to generate additional search queries.

In some implementations, the evaluation engine 240 can also classify a query expansion rule as undecided if the query expansion rule has not been classified as valid or invalid. This can occur if there is not enough data available to determine performance metrics for the query expansion rule. In some implementations and in response to classifying a query expansion rule as undecided, the evaluation engine 240 can perform additional monitoring of the query expansion rule. The additional monitoring by the evaluation engine 240 can provide additional data regarding the performance metrics. The additional data can facilitate the determination of a corresponding performance metric for the query expansion rule. In turn, the evaluation engine 240 can classify the query expansion rule as valid or invalid based on the performance metric.

In some implementations, a content item may under-perform or over-perform when selected in response to a particular expanded query that it is considered an outlier. For example, a query expansion rule can have a mean click-through rate of 5% with a standard deviation of 0.3%. In this example, if a particular content item has a click-through rate of 0.1% when selected in response to the expanded query it may be identified as an outlier. An outlier content item may be individually disabled from being presented in response to the expanded query without disabling the query expansion rule itself.

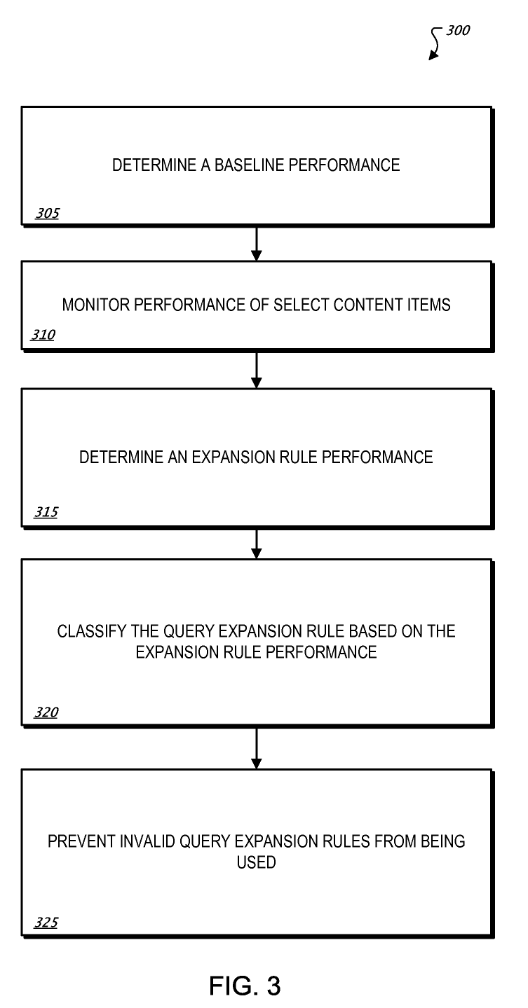

FIG. 3 is a flow diagram of an example process 300 for determining the performance of a query expansion rule. The process 300 can be implemented, for example, in a content item identification system 200. In some implementations, a query expansion engine 210 and a content item identification engine 225 can be integrated into the content item identification system 200. In some implementations, the content item identification system 200 can be integrated into an advertising system manager 104 of an online advertising environment 100.

Stage 305 determines a baseline performance. The baseline performance can be determined for example, by determining the performance for any content item that is presented. For example, the baseline performance can be the click-through rate for any content item presented in the web page regardless of whether a query expansion rule was used. Alternatively, the baseline performance metric can be based on any other metric (e.g., click-through rate*cost-per-click).

In some implementations, the baseline performance can include a baseline performance distribution. The baseline performance distribution represents the distribution of the performance samples that are used to determine the baseline performance.

Stage 310 monitors performance of selected content items. The selected content items can be selected in response to an expanded query. The performance can be monitored, for example, by monitoring metrics associated with the content items. For example, the number of clicks that the content items receive can be monitored. Similarly, the number of impressions for the content items can be monitored. A click-through rate can be determined from the click count and the impression total.

The expanded query can be any word or group of words that are identified, for example, by a query expansion engine 210 that are related to a search query submitted to a search engine 205 by a user device 108. The query expansion engine 210 can apply query expansion rules retrieved from an expansion rule store 215 to the search query to identify the expanded query 220. The expansion rules can be rewrite rules that are applied to search queries 205. For example, the rewrite rules can be based on semantic rules.

In some implementations, a query expansion rule can be applied to the search query to produce additional, relevant words or phrases that can be used as an expanded query 220. For example, applying an expansion rule to a search query of “cars” may produce the additional, relevant words of “new cars” and “used cards” that can be used as an expanded query 220.

In some implementations, the query expansion rules can be applied to the search query to remove a word or multiple words from the search query to produce more relevant search query topics 220. For example, some search words can add ambiguity to the search query; therefore, removing those search words can produce more relevant search query topics 220.

Stage 315 determines an expansion rule performance. The expansion rule performance can be determined, for example, based on the performance of the content items that are presented in response to the application of the query expansion rule. The performance of the content items presented in response to the application of the query expansion rule can be used to determine the performance of the query expansion rules (i.e., because the query expansion rules are used to generate additional search phrases that are related to the search query submitted by the user device 108). The performance can be monitored, for example, by an evaluation engine 240.

In some implementations, the performance can be determined by determining the number of interactions (e.g., clicks) that content items received when presented in response to the expanded query 220. The number of clicks can be compared to the baseline performance to determine if the content items outperform the baseline performance.

In some implementations, a confidence level can be determined for the query expansion rule. The confidence level can represent the confidence that the query expansion rule will generate an expanded query that will result in the selection of content items that perform better than the baseline performance.

Stage 320 classifies the query expansion rule based on the expansion rule performance. In some implementations, the query expansion rule can be classified as valid if the expansion rule performance satisfies a threshold. Conversely, the query expansion rule can be classified as invalid if the expansion rule performance does not satisfy a threshold. The threshold can be, for example, a confidence level that the content items presented in response to the expanded queries identified by the query expansion rule will perform better than the baseline performance.

In some implementations, query expansion rules that are not classified as valid or invalid can be classified as unknown. Unknown query expansion rules can be, for example, query expansion rules that have insufficient data for determining performance. In some implementations, unknown query expansion rules can be selected for additional monitoring. The additional monitoring can provide additional data that can be used to determine the expansion rule performance and, in turn, classify the query expansion rule.

Stage 325 prevents invalid query expansion rules from being used. Invalid query expansion rules identify expanded queries that result in under-performing content items relative to the baseline performance. The invalid query expansion rules can be prevented from being used, for example, by disabling or deleting the query expansion rule. Alternatively, the invalid query expansion rule can be edited and submitted for additional monitoring so that the performance of the edited query expansion rule can be determined and/or compared to the performance of the invalid expansion rule.

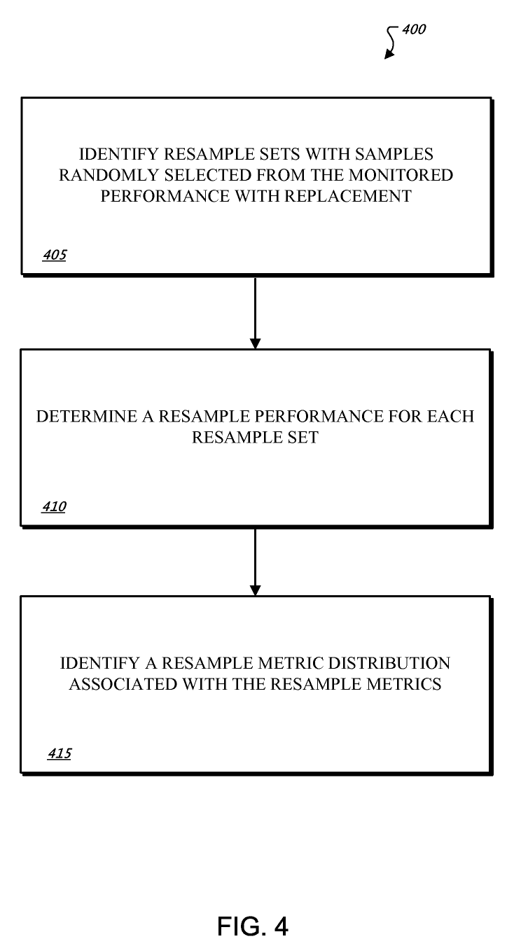

FIG. 4 is a flow diagram of an example process 400 for determining a baseline performance. The process 400 can be implemented, for example, as a bootstrap estimation. The process 400 can be implemented, for example, in an evaluation engine 240 of a content item identification system 200.

Stage 405 identifies resample sets with samples randomly selected from the monitored performance with replacement. In some implementations, the resample sets can have the same number of samples as the monitored performance. Since the samples of the resample sets are selected randomly or pseudo-randomly with replacement, many of the resample sets will not contain all of the same sample points as the monitored performance. For example, a resample set can have multiple instances of values in the monitored performance, while not including some of the value. The resample sets represent data sets that could have been collected if additional monitoring periods were performed. Since the monitored performance data represent the overall performance of the content items, the resample sets similarly represent the overall performance of the content items.

Stage 410 determines a resample performance metric for each resample set. The resample performance metric can be, for example, a mean click count. The resample performance metric can be a baseline performance metric characterizing the resample sets.

Stage 415 identifies a resample metric distribution associated with the resample metrics. The resample distribution can be identified from the resample metrics, for example, by plotting the number of resample metrics having corresponding values on a graph. The metric distribution can be used, for example, to determine the variance associated with the resample metric. For example, a standard deviation or variance can be determined for the distribution.

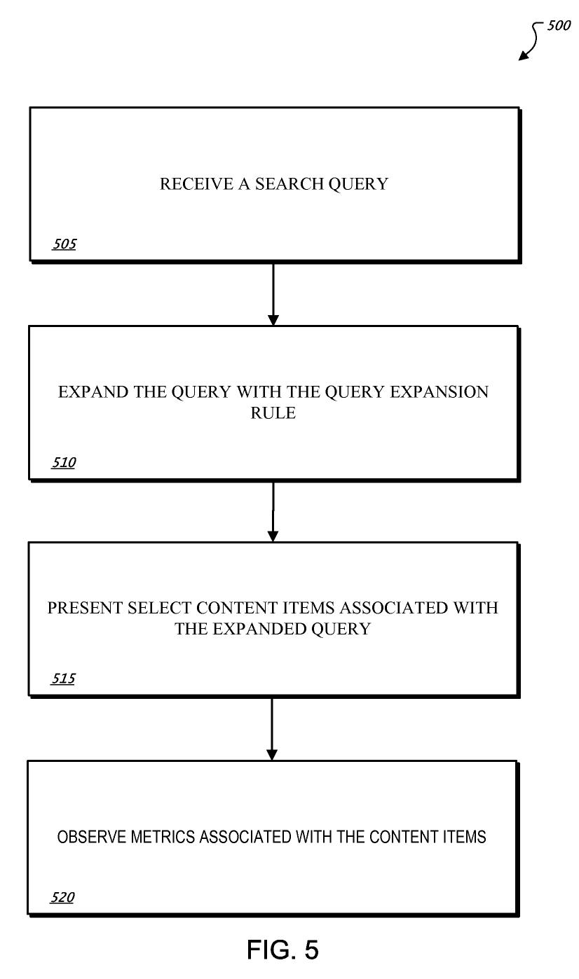

FIG. 5 is a flow diagram of an example process 500 for monitoring performance of the content items selected in response to an expanded query. The process 500 can be implemented, for example, in an evaluation engine 240 of a content item identification system 200.

Stage 505 receives a search query. The search query can be received, for example, from a user device 108. The search query can be a phrase submitted to facilitate a search for content. The search query can be received by a search engine 205.

Stage 510 expands the query with a query expansion rule. The query expansion rule can be based on semantic rules for identifying words/phrases that are related to the search query. The query expansion rule can identify additional phrases to be searched or the expansion rule engine can identify, for example, generic terms that can be removed to improve search results and selection of content items. The query expansion rule can be applied, for example, by a query expansion engine 210.

Stage 515 presents select content items associated with the expanded query. The content items are selected based on, for example, the content items' relevance to the expanded query. The relevance between the content items and the expanded query can be determined, for example, by comparing keywords associated with the content items to the expanded query. Keywords that are closely related to the phrases contained in the expanded query can identify content items that are closely related to the expanded query.

For example, if a search for “cars” is performed, a query expansion rule may identify an expanded query including the phrase “new cars.” Based on the inclusion of new cars, an advertisement for a new car dealership may be selected for presentation because “new cars” is closely related to “cars.” However, an advertisement for helicopters would likely not be selected for presentation.

Stage 520 observes metrics associated with the content items. The metrics can be used to determine the performance of the content items, and, in turn, the performance of a corresponding query expansion rule. Some examples of metrics that can be observed are the number of impressions, the click count, and presentation location.

The number of impressions for the content items is the number of times that a content item is selected for presentation based on an expanded query identified by the query expansion rule. The number of impressions can be observed for example, by incrementing a counter each time the content item is displayed after receiving the expanded query based on the query expansion rule.

The click count is a measure of how many times that a user device 108 clicked the content item. The click count can be associated with how relevant the content item is to the search query. The click count can be normalized to account for the placement of the content item on the web page and the configuration of the web page (e.g., the number and placement of content items on the page). The click count can be observed, for example, by incrementing a counter each time information is received indicating that the content item was clicked.

The presentation location of the content item can be observed by receiving data from the publisher 106 indicating the position of the content item on the web page. Additionally, information regarding the configuration of the web page can be received. Information identifying the location of the content items in the web page and the configuration of the web page can be used to normalize performance metrics associated with the content items.

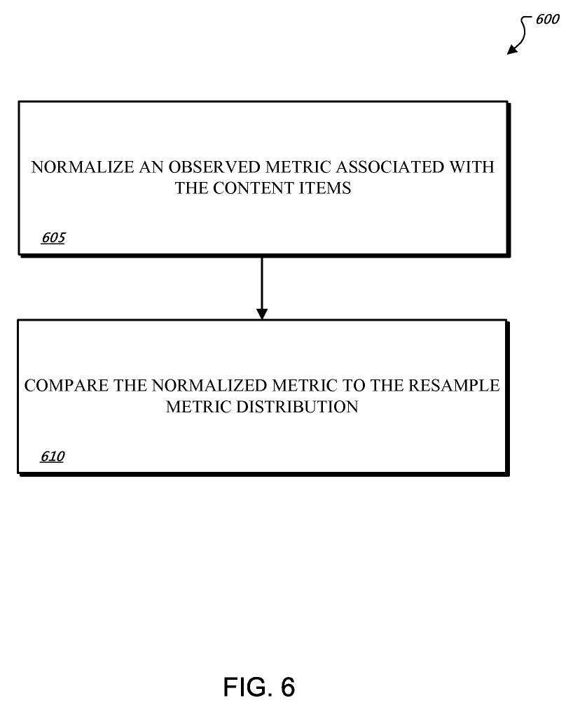

FIG. 6 is a flow chart illustrating an example process 600 for determining expansion rule performance. The process 600 can be implemented, for example, in an evaluation engine 240 of a content item identification system 200.

Stage 605 normalizes an observed metric associated with selected content items. In some implementations, the observed metric can be normalized by applying a normalization constant to the observed data. An example normalization constant for normalizing a click count is represented by the ratio of the number of resample sets used to create the resample metric distribution relative to the number of impressions in the monitored data. This normalization constant can be applied to an observed click count associated with a query expansion rule to compare the performance of the query expansion rule to the resample metric distribution.

Stage 610 compares the normalized metric to the resample metric distribution. The normalized metric can be, for example, a normalized click count. The resample metric distribution can be a click count distribution for the resample sets. The normalized click count is compared to the click count distribution to determine if the normalized click count satisfies a threshold value associated with the distribution. For example, a publisher can specify that only query expansion rules that out-perform 97.5% of the resample click counts in the resample distribution will be used. Accordingly, the normalized click count can be compared to the click count distribution to determine if the normalized click count is greater than 97.5% of the resample click counts.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter in this specification have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method, comprising:
determining a baseline performance that represents a performance of one or more content items; and
monitoring performance of selected content items wherein, the selected content items are selected from the one or more content items in response to an expanded query.

2. The method of claim 1, further comprising:
classifying the query expansion rule based on the expansion rule performance; and
determining an expansion rule performance based on the performance of the select content items relative to the baseline performance.

3. The method of claim 2, wherein classifying the query expansion rule comprises:
classifying the query expansion rule as invalid if the query expansion rule performance does not satisfy a threshold performance level; and
classifying the query expansion rule as valid if the query expansion rule performance satisfies the threshold performance level.

4. The method of claim 3, further comprising classifying the query expansion rule as unknown if the query expansion rule performance is not classified as valid or invalid.

5. The method of claim 3, further comprising preventing invalid query expansion rules from being used in selecting selected content.

6. The method of claim 1, wherein determining a baseline performance that represents the performance of one or more content items comprises determining a bootstrap estimation of a metric.

7. The method of claim 6, wherein determining a bootstrap estimation of a metric comprises:
identifying resample sets with samples pseudo-randomly selected from the monitored performance with replacement;
determining a resample performance metric for each resample set; and
identifying a resample metric distribution associated with the resample metrics.

8. The method of claim 7, wherein determining the expansion rule performance based on the performance of the selected content items relative to the baseline performance and the baseline performance distribution comprises:
normalizing an observed metric associated with the selected content items; and
comparing the normalized metric to the resample metric distribution to determine if the normalized metric satisfies a threshold value associated with the distribution.

9. The method of claim 1, wherein monitoring performance of the selected content items selected from the one or more content items in response to the expanded query identified by the query expansion rule comprises:
receiving a search query;
expanding the query with a query expansion rule;
presenting selected content items associated with the expanded query; and
observing metrics associated with the selected content items.

10. A system, comprising:
an evaluation engine to identify an expansion rule performance based on a baseline performance of one or more content items and a monitored performance of selected content items, wherein, the selected content items are selected from the one or more content items in response to an expanded query.

11. The system of claim 10, further comprising:
a query expansion engine to identify an expanded query based on a received query; and
a content item identification engine to select content items that are associated with the received query and the expanded query.

12. The system of claim 10, wherein the query expansion rule is classified as valid if the expansion rule performance satisfies a threshold.

13. The system of claim 10, wherein the query expansion rule is classified as invalid if the expansion rule performance does not satisfy a threshold.

14. The system of claim 10, wherein the expansion rule performance comprises:
a metric; and
a variance associated with the metric.

15. The system of claim 10, wherein the evaluation engine is configured to determine a bootstrap estimate of a performance metric.

16. The system of claim 15, wherein the evaluation engine is configured to determine a bootstrap distribution.

17. The system of claim 15, wherein the expansion rule performance comprises a confidence level that the selected content item presented in response to the expanded query outperforms the bootstrap estimate.

18. The system of claim 17, wherein the confidence level comprises a portion of the distribution that is outperformed by the content items presented in response to the expanded query.

19. The system of claim 15, wherein the bootstrap estimate comprises a number of clicks.

20. The system of claim 10, wherein the expansion rule performance comprises a click count associated with the content items presented in response to the expanded query.

21. The system of claim 10, wherein the expansion rule performance comprises a click-through rate associated with the content items presented in response to the expanded query.

22. A device, comprising:
means for determining a baseline performance of one or more content items; and
means for monitoring an observed performance of a selected content item, wherein the selected content item is presented in response to an expanded query identified by a query expansion rule;

23. The device of claim 22, further comprising means for determining a confidence level that the selected content item presented in response to the expanded query outperforms the baseline performance.

24. The device of claim 23, further comprising means for disabling a query expansion rule that does not have a threshold confidence level of outperforming the baseline performance.
